(19) United States
(12) Patent Application Publication
(10) Pub. No.: US 2025/0253088 A1
(43) Pub. Date: Aug. 7, 2025

(54) INTEGRATED MAGNETIC COMPONENT

(71) Applicant: Delta Electronics (Thailand) Public Co., Ltd., Samutprakarn (TH)

(72) Inventors: Hugues NJIENDE, Paderborn (DE); Sergey TIKHONOV, Bad Sassendorf (DE)

(21) Appl. No.: 19/026,441

(22) Filed: Jan. 17, 2025

(30) Foreign Application Priority Data
Feb. 7, 2024 (EP) 24156378.2

(51) Int. Cl. H01F 27/26; H01F 17/06

(52) U.S. Cl. CPC H01F 27/266; H01F 17/062

(57) ABSTRACT

The disclosure concerns an integrated magnetic component, comprising a common mode inductance formed by a common mode core and winding wound around the common mode core; a differential mode inductance formed by a differential mode core and the winding, an axial direction being defined as parallel to a substantial longitudinal extension of the differential mode core; and a baseplate which holds the common mode inductance and the differential mode inductance, wherein the baseplate integrally comprises a cavity portion housing the differential mode core and at least one sidewall at least partially surrounding an outer surface of the winding and/or of the common mode core opposite the differential mode core along a radial direction perpendicular to the axial direction.

### CROSS-REFERENCE TO RELATED APPLICATIONS

This application claims priority to European Patent Application No. 24156378.2, filed on Feb. 7, 2024, which is hereby incorporated by reference in its entirety.

### TECHNICAL FIELD

The disclosure concerns an integrated magnetic component.

### BACKGROUND

Conventionally, integrated magnetic components for common mode chokes are known from for example EP 3 683 811 A1. Therein, the integrated magnetic component comprises a common mode inductance and a differential mode inductance, wherein the common mode inductance is formed by a common mode core and winding wound around the common mode core. Further, the integrated magnetic component comprises a differential mode inductance formed by a differential mode core and said winding. Furthermore, said integrated magnetic component comprises a printed circuit board which holds the aforementioned components.

Furthermore, from JP2021114487A, an inductor for a common mode choke is known. The inductor includes a fixing member, a magnetic core, and a coil. The fixing member is provided with partition plate portions which partition sections of the coil and with bottom plates on which the magnetic core is mounted.

From US 2022/0044860 A1, a magnetic device for a common mode choke with a base, a wound core, and a spacer is known.

From TWM 633453 U, an inductor for a common mode choke is known which comprises a magnetic core having a hollow portion, in which a magnetic element is provided, and a base holding these elements.

However, in these magnetic components, it is required to position especially the common mode and differential mode magnetic cores so as to avoid a saturation of the differential mode core. Furthermore, it is challenging therein to position the components while manufacturing so as to also ensure electrical insulation. Especially during potting of such magnetic components, the components can be shifted or moved relative to one another, thereby causing non symmetric gaps or insulation distances between the components.

### SUMMARY

It is an object of the present disclosure to overcome these deficiencies. In particular, it is an object of the present disclosure to provide an integrated magnetic component which can be easily manufactured while ensuring appropriate insulation and saturation distances between components thereof.

In particular, the solution of these objects is achieved by the integrated magnetic component provided in the present disclosure. The integrated magnetic component comprises a common mode inductance formed by a common mode core and winding wound around the common mode core. Further, the integrated magnetic component comprises a differential mode inductance formed by a differential mode core and the winding. Therein, an axial direction is defined as being parallel to a substantial longitudinal extension of the differential mode core. Furthermore, the integrated magnetic component comprises a baseplate which holds the common mode inductance and the differential mode core. The integrated magnetic component is characterized in that the baseplate integrally comprises a cavity portion and at least one sidewall. The cavity portion houses the differential mode core. The at least one sidewall at least partially surrounds an outer surface of the winding and/or of the common mode core opposite the differential mode core along a radial direction perpendicular to the axial direction.

Thereby, since the at least one sidewall and the cavity portion of the baseplate are formed integrally, the common mode inductance and the differential mode inductance can be positioned easily and reliably during manufacturing of the integrated magnetic component. Preferably, the at least one sidewall provides insulation between the winding and other components nearby the integrated magnetic component and/or provides separation/saturation distance between the common mode core and such other components. Thereby, the integrated magnetic component provides easy manufacturing as well as providing reliable insulation and saturation distances for components thereof. Further yet, the at least one sidewall preferably also prevents a shift/movement of the winding and/or common mode core, such that positions of these components are secured.

In one advantageous embodiment, the baseplate further comprises through-holes which guide terminations of coils of the winding. Therein, the terminations, i.e. ends, of the winding are inserted into and through the through-holes. Thereby, the through-holes of the baseplate provide separation and insulation of the coil terminations. Further yet, the through-holes provide positioning of these coil terminations, which allows easy and reliable attachment of the integrated magnetic component to other components, for example to a printed circuit board (henceforth “PCB”).

Further advantageously, the baseplate comprises a substantially flat plate-shaped plate portion from which the at least one sidewall projects. Preferably, the plate portion and the at least one sidewall are formed integrally with one another. The plate portion is preferably configured to hold the common mode and the differential mode inductances and their components.

Preferably, the through-holes are formed in the plate portion of the baseplate. Thereby, the coil terminations are preferably guided downward, i.e. along the axial direction away from the plate portion and the inductances.

In addition or alternatively thereto, the through-holes are preferably formed in at least one of the at least one sidewall. Thereby, the coil terminations are preferably guided radially outward, i.e. in a direction parallel to the radial direction.

Further advantageously, the at least one sidewall, especially one or more or all sidewall(s), projects substantially perpendicularly from a plane defined by extensions of the plate portion. In other words, the plate portion, which is substantially flat plate-shaped, defines an extension plane via its substantial extensions (i.e. by those not including its thickness), and the at least one sidewall preferably projects substantially perpendicularly therefrom. In particular, the at least one sidewall projects from the plate portion in a direction parallel to the axial direction. Preferably, the axial direction is perpendicular to the aforementioned extension plane of the plate portion.

In some preferable embodiments, the at least one sidewall defines an outer perimeter or an outer wall of the integrated magnetic component, especially of the baseplate. Preferably therein, no components of the integrated magnetic component extend past the at least one sidewall in a radial direction, with the possible exception of radially guided coil terminations. In the preferable combination with the through-holes formed in the plate portion, i.e. the coil terminations being guided axially downward, no components of the integrated magnetic component extend past the at least one sidewall in a radial direction. Further preferably, a radially outer surface of the at least one sidewall is flush with a radial outer perimeter of the plate portion.

Preferably, the at least one sidewall completely surrounds, along a circumferential direction perpendicular to the radial direction and perpendicular to the axial direction, the winding and/or the common mode core. Preferably, the at least one sidewall in this embodiment is provided as a single sidewall, which completely surrounds the winding and/or the common mode core along the circumferential direction. Preferably, the term “completely surrounds” does not exclude the possibility of through-holes being provided in the sidewall. Furthermore, “the at least one sidewall completely surrounds” also preferably encompasses a case in which multiple sidewalls are provided, which are not separated by gaps along the circumferential direction. For example, the multiple sidewalls may overlap along the radial direction, i.e. may comprise portions being arranged behind one another along radial direction, and next to one another when following the circumferential direction.

Further preferably, the at least one sidewall may comprise multiple sidewalls which, in the preferable case of completely surrounding in the circumferential direction, integrally include a connecting portion which connects the multiple sidewalls, for example as a base of the sidewalls which is integrally connected with the plate portion. In such a case, the multiple sidewalls may be separated by gaps at portions not including said connecting portion.

In some preferable embodiments, a height of the at least one sidewall along the axial direction is equal to or greater than a height of the winding and/or of the common mode core. In the preferable case of the at least one sidewall being integral with and projecting axially from the plate portion, the height of the sidewall is preferably defined as being measured or taken from an axial bottom of the plate portion to an axial top of the least one sidewall, i.e. encompassing a height of the at least one sidewall as well as a thickness of the plate portion.

Preferably, in the case of multiple sidewalls, the heights of the sidewalls are all equal or different from one another. For example, depending on requirements of outer dimensions of the integrated magnetic component, the multiple sidewalls may be formed with different heights accordingly.

Further yet, in the case of a single sidewall, the height of the sidewall is preferably substantially the same along the circumferential direction, especially in combination with the sidewall completely surrounding along the circumferential direction.

Thereby, the at least one sidewall provides protection, insulation, and separation of the components, especially with respect to possible other components axially above the integrated magnetic component. Further yet, the at least one sidewall thereby also provides protection from damages caused by dropping the integrated magnetic component.

In some preferable embodiments, an inner space defined by the at least one sidewall is filled with glue and/or potting material. Thereby, the at least one sidewall provides an enclosure for the glue and/or potting material, for instance resin, and preferably functions as an outer case of the integrated magnetic component. Preferably, the at least one sidewall is not removed after potting.

In some preferable embodiments, the cavity portion which houses the differential mode core comprises one or more cavity wall portions which project in the axial direction from the plate portion. The cavity wall portions advantageously provide an enclosure (cavity) for the differential mode core, and simultaneously advantageously provide insulation/separation of the differential mode core with respect to the other components of the integrated magnetic component.

Preferably, the one or more cavity wall portions project in substantially parallel to the at least one sidewall. Thereby, insulation/separation distances between the differential mode core, which is inserted into the cavity portion and surrounded at least partially by the cavity wall portions, and other components are held substantially constant along the axial direction.

Further preferably, the one or more cavity wall portions are formed integrally with the plate portion. Thereby, the differential mode core and the common mode inductance can be easily inserted into the baseplate, which increases manufacturing efficiency and reliability and which increases reliability of insulation/separation distances between components of the integrated magnetic component.

In some advantageous embodiments, a height of the cavity portion along the axial direction is equal to or greater than a height of the differential mode core. Thereby, the differential mode core is reliably held by the cavity portion. Furthermore, a separation distance between the differential mode core and any further components axially above the integrated magnetic component is guaranteed. The differential mode core is also protected from damage thereby.

Preferably, the height of the cavity portion along the axial direction is substantially equal to the height of the at least one sidewall. Such an embodiment provides ease of manufacturing, protection of the components of the integrated magnetic component, as well as reliable insulation/separation distances thereof, especially along the axial direction.

Preferably, the integrated magnetic component comprises a lid, especially comprising or consisting of a layer of thermal glue and/or of an insulating sheet (for example, Kapton®), and/or comprising or consisting of a metal sheet provided with or wrapped in insulating material such as Kapton®. This lid is preferably further attached to a chassis or is a part of a chassis.

Furthermore, in preferable embodiments in which a lid is provided, such a lid is arranged substantially flush, especially perpendicular to the axial direction, on the at least one sidewall and the cavity portion, which also provides additional reliability of insulation/separation.

Advantageously, the cavity portion is filled with glue and/or potting material. Depending on possible fitting and allowance of the differential mode core in the cavity, the glue and/or potting material is disposed preferably only axially above and/or below the differential mode core or is disposed surrounding the differential mode core radially and axially above and/or below. Thereby, insulation/separation distances between the differential mode core and other components of the integrated magnetic component can be reliably achieved. Furthermore, since preferably no mold is needed for gluing/potting, manufacturing is made more efficient and reliable.

In some preferable embodiments, the cavity portion comprises a plurality of separation walls which respectively extend to the common mode core and separate winding portions of the winding wound around the common mode core. Thereby, the baseplate integrally also provides insulation and separation of the windings of the common mode core, thereby increasing efficiency and reliability of manufacturing. Furthermore, the separation walls can prevent slipping of the winding, thereby further increasing reliability of manufacturing and overall lifetime/reliability of the integrated magnetic component.

Preferably, the separation walls are provided on a radial outer surface of the cavity portion and project and extend radially from the cavity wall portions of the cavity portion.

Preferably, the common mode core is arranged such that an inner surface thereof contacts the separation walls. Thereby, a length, especially a radial length, of the separation walls advantageously provides or predetermines a separation distance between the common mode core and further components of the integrated magnetic component, especially between the common mode and differential mode core. Thus, manufacturing is made more reliable and efficient, and lifetime of the integrated magnetic component is further increased.

In advantageous embodiments, the integrated magnetic component comprises a plurality of winding portions, for example three or more, four or more, or six or more winding portions. In particular, the number of winding portions may correspond to a number of phases of the integrated magnetic component, for example four winding portions in a case of three phases and a neutral.

Advantageously, the winding comprises four separate winding portions and the cavity portion comprises four separation walls separating and insulating the winding portions.

In some preferable exemplary embodiments, the common mode core is ring-shaped, especially oval-ring shaped or circular-ring-shaped, in plan view along the axial direction. In some embodiments, the common mode core is preferably rectangular ring-shaped (also commonly referred to as a “D-core”), especially with rounded corners. The aforementioned plan view is preferably a cross-sectional view on a plane which is plane-perpendicular to the axial direction.

In further preferable exemplary embodiments, the differential mode core and the cavity portion are cylinder-shaped. Preferably, in combination with being parallel to the at least one sidewall, the at least one sidewall (i.e. the one or all sidewalls taken together) and the cavity portion are respectively cylinder shaped. Advantageously, the cavity portion and the at least one sidewall are not necessarily of the same shape or parallel to one another. For instance, the differential mode core and the cavity portion may be cylinder shaped, while the common mode core and the at least one sidewall are rectangular.

Further preferably, in some embodiments, the differential mode core and the cavity portion are rectangle-shaped. Preferably, in combination with being parallel to the at least one sidewall, the at least one sidewall (i.e. the one or all sidewalls taken together) and the cavity portion are respectively rectangle-shaped. As elucidated above, the at least one sidewall and the cavity portion are not necessarily of the same shape. For instance, with this configuration, the cavity portion is preferably rectangle-shaped and the at least one sidewall is cylinder-shaped.

Preferably, a thickness in a radial direction of the one or more cavity wall portions corresponds to a predetermined air gap between the common mode core and the differential mode core. Thereby, the cavity wall portions are preferably configured with a predetermined thickness so as to avoid saturation of a differential current through the winding. “Air gap” herein refers, as common, to a space of magnetic permeability similar to that of air (even if it is filled with a material such as that of the cavity wall portions instead of air).

In some advantageous embodiments, the baseplate comprises or consists of a plastic or ceramic material.

In the foregoing and in the following, the term “integral” preferably refers to the baseplate being formed, with its corresponding components, as a single piece. For instance, the baseplate is preferably manufactured using with a single mold, especially in the case of injection molding. The term “integral” preferably refers to a monolithic structure. In other preferable embodiments, the components of the baseplate are individually manufactured, such as with injection molding, and glued or welded together. Preferably, the term “integral” in the foregoing and in the following does not encompass separate components held together merely via potting or resin material.

The common mode core and/or the differential mode core preferably comprise or consist of a magnetic material.

The present disclosure also concerns a common mode choke comprising at least one integrated magnetic component according to any one of the foregoing described examples.

The foregoing described preferable embodiments and configurations may be combined.

Further details, advantages, and features of the preferred embodiments of the present disclosure are described in detail with reference to the figures.

### BRIEF DESCRIPTION OF DRAWINGS

FIG. 1 shows an exploded view of an integrated magnetic component according to a first embodiment of the present disclosure.

FIG. 2 shows an assembled perspective view of the integrated magnetic component according to the first embodiment of the present disclosure.

FIG. 3 shows an assembled top view of the integrated magnetic component according to the first embodiment of the present disclosure.

FIG. 4 shows an exploded view of an integrated magnetic component according to a second embodiment of the present disclosure.

FIG. 5 shows an assembled perspective view of the integrated magnetic component according to the second embodiment of the present disclosure.

FIG. 6 shows an assembled top view of the integrated magnetic component according to the second embodiment of the present disclosure.

FIG. 7 shows an exploded view of an integrated magnetic component according to a third embodiment of the present disclosure.

FIG. 8 shows an assembled perspective view of the integrated magnetic component according to the third embodiment of the present disclosure.

FIG. 9 shows an exploded view of an integrated magnetic component according to a fourth embodiment of the present disclosure.

FIG. 10 shows an assembled perspective view of the integrated magnetic component according to the fourth embodiment of the present disclosure.

### DESCRIPTION OF EMBODIMENTS

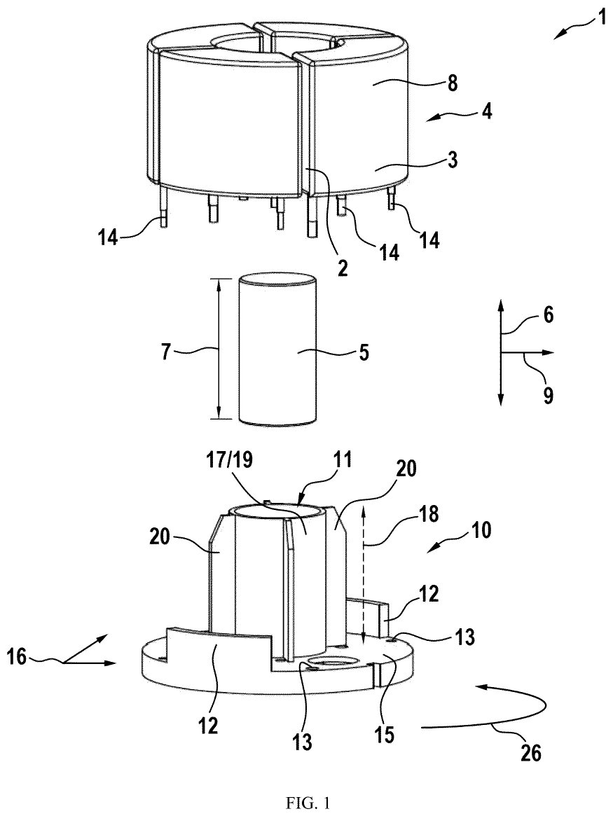

A first embodiment of the present disclosure will be described with reference to FIGS. 1 to 3.

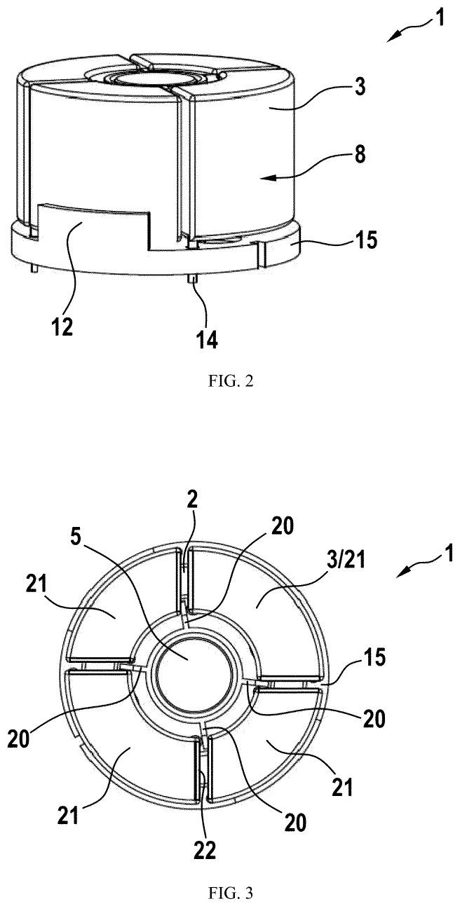

FIG. 1 shows an exploded view of an integrated magnetic component 1 according to a first embodiment of the present disclosure. FIG. 2 shows an assembled perspective view of the integrated magnetic component 1 according to the first embodiment of the present disclosure. FIG. 3 shows an assembled top view of the integrated magnetic component 1 according to the first embodiment of the present disclosure.

The integrated magnetic component 1 comprises a common mode inductance 4 formed by a common mode core 2 and winding 3 wound around the common mode core 2. Further, the integrated magnetic component 1 comprises a differential mode inductance formed by a differential mode core 5 and said winding 3.

Herein and for the following, an axial direction 6 is defined as being parallel to a substantial longitudinal extension 7 of the differential mode core 5.

Furthermore, the integrated magnetic component 1 comprises a baseplate 10 which holds the common mode inductance 4 and the differential mode core 5. The baseplate 10 integrally comprises a cavity portion 11 and at least one sidewall 12. In the present embodiment as shown in FIG. 1, the baseplate 10 comprises exactly two sidewalls 12.

The cavity portion 11 houses the differential mode core 5. The sidewalls 12 here partially surround an outer surface 8 of the winding 3 and/or of the common mode core 2 opposite the differential mode core 5 along a radial direction 9 perpendicular to the axial direction 6.

Here, since the sidewalls 12 and the cavity portion 11 of the baseplate 10 are formed integrally, the common mode inductance 4 and the differential mode core 5 can be positioned easily and reliably during manufacturing of the integrated magnetic component 1.

As can be taken especially from FIGS. 2 and 3, the sidewalls provide insulation between the winding 3 and other components nearby the integrated magnetic component 1 and/or provide separation/saturation distance between the common mode core 2 and such other components. Thereby, the integrated magnetic component 1 provides easy manufacturing as well as providing reliable insulation and saturation distances for components thereof. Further yet, the sidewalls 12 also prevent a shift/movement of the winding 3 and/or common mode core 2, such that positions of these components are secured.

The baseplate 10 further comprises through-holes 13 which guide terminations 14 of coils of the winding 3. The terminations 14, i.e. ends, of the winding 3 are inserted into and through the through-holes 13. Thereby, the through-holes 13 of the baseplate 10 provide separation and insulation of the coil terminations 14.

The baseplate 10 has a substantially flat plate-shaped plate portion 15 from which the sidewalls 12 project. The plate portion 15 and the sidewalls 12 are formed integrally with one another. The plate portion 15 is configured to hold the common mode inductance 4 and the differential mode core 5.

The sidewalls project substantially perpendicularly from a plane 16 defined by extensions of the plate portion 15. In other words, the plate portion 15, which is substantially plate plate-shaped, defines an extension plane 16 via its substantial extensions (i.e. by those not including its thickness), and the sidewalls project substantially perpendicularly therefrom. In particular, the sidewalls project from the plate portion 15 in a direction parallel to the axial direction 6.

In this embodiment, the through-holes 13 are formed in the plate portion 15 of the baseplate 10. Thereby, the coil terminations 14 are guided downward, i.e. along the axial direction away from the plate portion 15 and the inductances 4, 5.

In addition or alternatively thereto, the through-holes 13 can be formed in at least one of the at least one sidewall 12. Thereby, the coil terminations 14 are preferably guided radially outward, i.e. in a direction parallel to the radial direction 9.

In the present embodiment, the cavity portion 11 which houses the differential mode core 5 comprises one cavity wall portion 17 which projects in the axial direction 6 from the plate portion 15. Here, the cavity wall portion 17 projects in substantially parallel to the sidewalls 12. Thereby, insulation/separation distances between the differential mode core 5, which is inserted into the cavity portion 11 and surrounded entirely by the cavity wall portion 17, and the other components are held substantially constant along the axial direction 6.

As shown in FIGS. 1 to 3 the cavity wall portion 17 is formed integrally with the plate portion 15 and the sidewalls 12. A height 18 of the cavity portion 11 along the axial direction 6 is equal to or greater than a height (longitudinal extension) 7 of the differential mode core 5. Furthermore, a radial thickness of the cavity wall portion 17 predetermines an air gap between the common mode core 2 and the differential mode core 5. Thereby, the differential mode core 5 is reliably held by the cavity portion 11.

The cavity portion 11 also comprises, on its radial outer surface 19, a plurality of separation walls 20 which respectively project in the radial direction 9 and separate winding portions 21 of the winding 3 wound around the common mode core 2 (see especially FIG. 3).

Here, the common mode core 2 is arranged such that a radially inner surface 22 thereof contacts the separation walls 20. Thereby, a radial length of the separation walls 20 advantageously provides or predetermines a separation distance between the common mode core 2 and further components of the integrated magnetic component 1, especially between the common mode core 2 and differential mode core 5. Thus, manufacturing is made more reliable and efficient, and lifetime of the integrated magnetic component 1 is further increased.

Advantageously, the winding 3 of the present embodiment comprises four separate winding portions 21 and the cavity portion 11 comprises four separation walls 20 separating and insulating the winding portions 21 from one another. The winding 3 may alternatively comprise two or three or six or more winding portions 21, especially corresponding to a number of phases of the integrated magnetic component.

In this exemplary embodiment, the common mode core 2 is circular-ring-shaped in plan view along the axial direction 6 (the view of FIG. 3). The differential mode core 5 and the cavity portion 11 are respectively cylinder-shaped.

As can be taken from FIGS. 1 to 3, the baseplate 10 is formed integrally with the cavity portion 11, the plate portion 15, and the sidewalls 12. The separation walls 20 and the cavity wall portions 17 of the cavity portion 11 are also formed integrally with the plate portion 15 and the sidewalls 12. In this embodiment, the entire baseplate 10 including its described constituent elements is formed as a single piece, and especially comprises plastic and/or ceramic. For example, the baseplate 10 is formed using a single mold, for example injection molding.

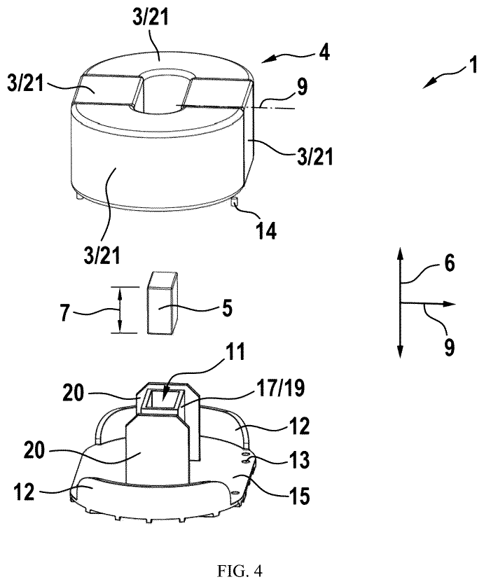

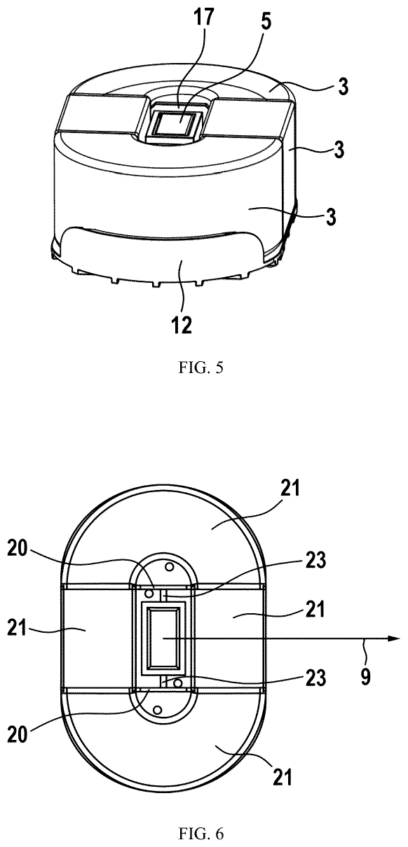

Now, a second embodiment of the present disclosure will be described with reference to FIGS. 4 to 6. FIG. 4 shows an exploded view of an integrated magnetic component 1 according to the second embodiment of the present disclosure. FIG. 5 shows an assembled perspective view of the integrated magnetic component 1 according to the second embodiment of the present disclosure. FIG. 6 shows an assembled top view of the integrated magnetic component 1 according to the second embodiment of the present disclosure.

As can be taken from FIGS. 4 to 6, the common mode core 2 of the present embodiment is oval-ring shaped. Furthermore, the differential mode core 5 and the cavity portion 11 are rectangle-shaped, particularly square-shaped. Due to the windings 3, the common mode core 2 is not directly visible in FIGS. 4 to 6.

In the present embodiment, two separation walls 20 extend to the common mode core 2 and separate winding portions 21 of the winding 3 wound around the common mode core 2. These separation walls 20 respectively extend along a direction parallel to the radial direction 9. Furthermore, as can be taken from FIG. 6, the cavity portion 11 comprises separation wall spacer portions 23, which distance the separation walls 20 from the cavity wall portions 17 to suitably separate the winding portions 21.

In the foregoing first and second embodiment, the sidewalls 12 each encompass/surround only a portion of the winding 3 and/or of the common mode core 2 along a circumferential direction 26 perpendicular to the radial direction 9 and perpendicular to the axial direction 6.

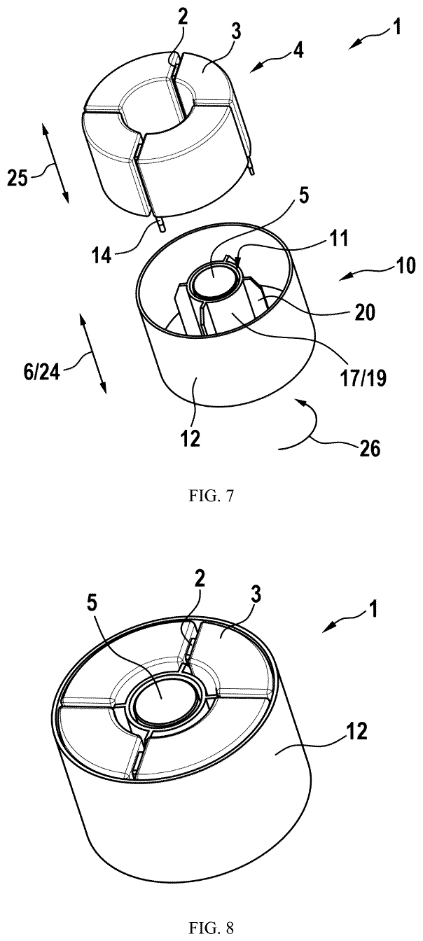

Now, with reference to FIGS. 7 and 8, a third embodiment of the present disclosure is described. FIG. 7 shows an exploded view of an integrated magnetic component 1 according to the third embodiment of the present disclosure, whereas FIG. 8 shows an assembled perspective view of the integrated magnetic component 1 according to the third embodiment of the present disclosure.

As can be taken from FIG. 7, the configuration of the common mode inductance 4 is similar to that of the first embodiment shown in FIGS. 1 to 3.

In FIG. 7, the differential mode core 5 is shown as already inserted into the cavity portion 11 of the baseplate 10.

In the present embodiment, the baseplate 10 comprises one sidewall 12. The sidewall 12 completely surrounds the winding 3 and the common mode core 2 along the circumferential direction 26.

Herein, a height 24 of the sidewall 12 along the axial direction 6 is equal to or greater than a height 25 of the winding 3 and/or of the common mode core 2. Further, the height 24 of the sidewall 12 is preferably substantially the same along the circumferential direction 26.

Although not shown, an inner space defined by the sidewall 12, in which the common mode core 2 and the winding 3 are housed, is preferably filled with glue and/or potting material. Thereby, the sidewall 12 provides an enclosure for the glue and/or potting material, for instance resin, and preferably functions as an outer case of the integrated magnetic component 1.

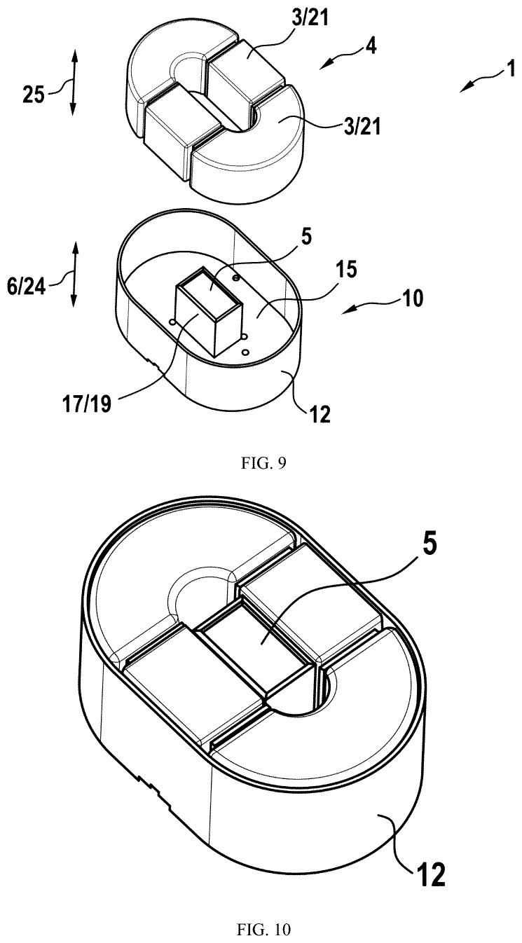

Now, with reference to FIGS. 9 and 10, a fourth embodiment of the present disclosure is described. FIG. 9 shows an exploded view of an integrated magnetic component 1 according to the fourth embodiment of the present disclosure, whereas FIG. 10 shows an assembled perspective view of the integrated magnetic component 1 according to the fourth embodiment of the present disclosure.

As can be taken from FIG. 9, the configuration of the common mode inductance 4 is similar to that of the second embodiment shown in FIGS. 4 to 6. The differential mode core 5 is also here shown as inserted into the cavity portion 11 of the baseplate 10.

In this example, the baseplate 10 does not comprise separating walls 20, which may be optional.

Furthermore, as with the third embodiment, the single sidewall 12 of the baseplate 10 has a height 24 equal to or greater than that of the common mode inductance 4 (of the common mode core 2 and/or of the winding 3). Thereby, also in this embodiment, the inner space defined by the sidewall 12 which houses the common mode inductance 4 and the differential mode inductance can be filled with potting or glue.

In the foregoing described embodiments three and four, the sidewall defines an outer perimeter or an outer wall of the integrated magnetic component 1, especially of the baseplate 10.

By the foregoing described embodiments, an integrated magnetic component 1 is achieved which provides easy and efficient manufacturing while also providing reliable insulation/separation distances between components thereof.

In addition to the foregoing written explanations, it is explicitly referred to FIGS. 1 to 10, wherein the figures in detail show circuit diagrams and configuration examples of the disclosure.

What is claimed is:

1. An integrated magnetic component, comprising:
a common mode inductance formed by a common mode core and winding wound around the common mode core;
a differential mode inductance formed by a differential mode core and the winding, an axial direction being defined as parallel to a substantial longitudinal extension of the differential mode core; and
a baseplate which holds the common mode inductance and the differential mode inductance;
wherein the baseplate integrally comprises a cavity portion housing the differential mode core and at least one sidewall at least partially surrounding an outer surface of the winding and/or of the common mode core opposite the differential mode core along a radial direction perpendicular to the axial direction.

2. The integrated magnetic component according to claim 1, wherein the baseplate further comprises through-holes which guide terminations of coils of the winding.

3. The integrated magnetic component according to claim 1, wherein the baseplate comprises a flat plate-shaped plate portion from which the at least one sidewall projects.

4. The integrated magnetic component according to claim 3, wherein the at least one sidewall projects substantially perpendicularly from a plane defined by extensions of the plate portion.

5. The integrated magnetic component according to claim 4, wherein the at least one sidewall projects parallel to the axial direction.

6. The integrated magnetic component according to claim 1, wherein the at least one sidewall defines an outer perimeter or an outer wall of the baseplate.

7. The integrated magnetic component according to claim 6, wherein the at least one sidewall completely surrounds, along a circumferential direction perpendicular to the radial direction and to the axial direction, the winding and/or the common mode core.

8. The integrated magnetic component according to claim 7, wherein a height of the at least one sidewall along the axial direction is equal to or greater than a height of the winding and/or of the common mode core.

9. The integrated magnetic component according to claim 7, wherein an inner space defined by the at least one sidewall is filled with glue and/or potting material.

10. The integrated magnetic component according to claim 3, wherein the cavity portion housing the differential mode core comprises one or more cavity wall portions which project in the axial direction from the plate portion.

11. The integrated magnetic component according to claim 10, wherein the one or more cavity wall portions project from the plate portion substantially parallel to the at least one sidewall.

12. The integrated magnetic component according to claim 1, wherein a height of the cavity portion along the axial direction is equal to or greater than a height of the differential mode core.

13. The integrated magnetic component according to claim 1, wherein the cavity portion is filled with glue and/or potting material.

14. The integrated magnetic component according to claim 1, wherein the cavity portion comprises a plurality of separation walls which respectively extend to the common mode core and separate winding portions of the winding wound around the common mode core.

15. The integrated magnetic component according to claim 14, wherein the winding comprises four or more separate winding portions and the cavity portion comprises four or more separation walls separating and insulating the winding portions.

16. The integrated magnetic component according to claim 1, wherein the common mode core is ring-shaped in plan view along the axial direction.

17. The integrated magnetic component according to claim 1, wherein the differential mode core and the cavity portion are cylinder-shaped.

18. The integrated magnetic component according to claim 1, wherein the differential mode core and the cavity portion are rectangle-shaped.

19. The integrated magnetic component according to claim 10, wherein a thickness in radial direction of the one or more cavity wall portions corresponds to a predetermined air gap between the winding and the differential mode core.

20. The integrated magnetic component according to claim 1, wherein the baseplate comprises or consists of a plastic or ceramic material.
